(19) United States
(12) Patent Application Publication
(10) Pub. No.: US 2020/0394519 A1
(43) Pub. Date: Dec. 17, 2020

(54) METHOD FOR OPERATING AN ARTIFICIAL NEURAL NETWORK

(71) Applicant: Robert Bosch GmbH, Stuttgart (DE)

(72) Inventors: Pia Petrizio, Sindelfingen (DE); Jens Eric Markus Mehnert, Malmsheim (DE); Rolf Michael Koehler, Dettenhausen (DE)

(21) Appl. No.: 16/961,491

(22) PCT Filed: Jan. 3, 2019
(86) PCT No.: PCT/EP2019/050092

§ 371 Date: Aug. 25, 2020

(30) Foreign Application Priority Data
Jan. 15, 2018 (DE) 10 2018 200 534.6

(51) Int. Cl. G06N 3/08; G06F 17/16; G06F 17/18

(52) U.S. Cl. CPC G06N 3/08; G06F 17/18; G06F 17/16

(57) ABSTRACT

A method for operating an artificial neural network is provided, including at least one convolution layer that is configured to convert an input matrix of the convolution layer into an output matrix, based on a convolution operation and a shift operation. The method includes ascertaining at least one first normalization value and one second normalization value based on inputs of the input matrix and/or based on a training data set, ascertaining a modified filter matrix based on an original filter matrix and based on at least one of the first normalization value and the second normalization value, and ascertaining a modified shift matrix based on an original shift matrix and based on at least one of the first normalization value and the second normalization value. The method further includes converting the input matrix into the output matrix by applying the modified filter matrix and the modified shift matrix.

### FIELD

The present invention relates in general to the field of artificial intelligence. In particular, the present invention relates to a method for operating an artificial neural network, and an artificial neural network that may be used, for example, for object recognition in vehicles.

### BACKGROUND INFORMATION

For training artificial neural networks, in particular multilayer and/or convolutional neural networks, training data supplied to the neural network, such as training images, are generally normalized and/or standardized. This may be used, among other things, to homogenize the training data of a training data set. In addition, objects and/or features possibly present in the training data may be emphasized and/or highlighted by the normalization.

After the training of the neural network and/or during operation of the trained neural network, generally also referred to as inference, the input data supplied to the neural network for interpretation and/or classification are generally normalized and/or standardized analogously to the training data. The normalization of the input data may be computationally intensive and/or time-consuming, and may require powerful hardware for carrying out the normalization.

### SUMMARY

By use of specific example embodiments of the present invention, an efficient and rapid method for operating an artificial neural network may be advantageously provided. In addition, an improved artificial neural network may be provided using specific embodiments of the present invention.

One aspect of the present invention relates to a method for operating an artificial neural network. The neural network includes at least one convolution layer and/or at least one convolutional layer that are/is configured to convert an input matrix of the convolution layer into an output matrix, based on a convolution operation and a shift operation, such as a linear shift. In accordance with an example embodiment of the present invention, the method includes a step of ascertaining at least one first normalization value and one second normalization value based on inputs of the input matrix and/or based on a training data set of the neural network. The method includes the following steps:
ascertaining a modified filter matrix based on an original filter matrix of the at least one convolution layer and based on at least one of the ascertained first normalization value and the second normalization value;
ascertaining a modified shift matrix based on an original shift matrix of the at least one convolution layer and based on at least one of the ascertained first normalization value and the second normalization value; and
converting the input matrix into the output matrix, using and/or based on the modified filter matrix and the modified shift matrix.

The method may refer to a method for training a neural network and/or a method for operating an already trained neural network. The neural network may refer, for example, to a multilayer artificial neural network that may have multiple convolution layers. Alternatively or additionally, the neural network may refer to a convolutional neural network. For example, the neural network may include multiple convolution layers downstream from one another, such as concealed layers. In the context of the present disclosure, the at least one convolution layer may refer, for example, to an input layer and/or first layer of the neural network, a convolution layer downstream from the input layer, and/or a concealed layer of the neural network.

The input matrix may in general refer to an arbitrary input data element of the at least one convolution layer. If the neural network includes multiple convolution layers, the input matrix may refer to an input data element for any of these convolution layers. For the input layer and/or the first layer of the neural network, the input matrix may refer to an input data element, such as an input image, that is supplied to the neural network. For a convolution layer downstream from the input layer, the input matrix may also refer to the input data element which is supplied to this convolution layer, and which, for example, may correlate with an output matrix of an upstream convolution layer and/or may correspond to this output matrix. The input matrix may also have an arbitrary dimension. In particular, the input matrix may be one-dimensional or multidimensional. In other words, the input matrix may refer to a one-dimensional or multidimensional input tensor.

The output matrix may refer to an arbitrary output data element of the at least one convolution layer, which may be generated by the convolution layer based on the input matrix, using the convolution operation and the shift operation. If the neural network includes multiple convolution layers, the output matrix may be an output data element of any convolution layer. For multiple convolution layers downstream from one another, in addition the output matrix of an upstream convolution layer may also form an input matrix of a convolution layer downstream from this upstream convolution layer, may correlate with the input matrix of the downstream convolution layer, and/or may correspond to same. The output matrix may also have an arbitrary dimension. In particular, the output matrix may be one-dimensional or multidimensional. In other words, the output matrix may refer to a one-dimensional or multidimensional output tensor. In addition, the output matrix may have the same dimension as the input matrix of the particular convolution layer, or may have a dimension that is different from the input matrix of the particular convolution layer.

The original filter matrix may refer, for example, to the filter matrix of the convolution layer as used during the training of the neural network and/or that has been ascertained for this convolution layer. The modified filter matrix may refer to the filter matrix that is used by the associated convolution layer during operation of the trained neural network, also referred to as inference. Analogously, the original shift matrix may refer to the shift matrix of the convolution layer as used during the training of the neural network and/or that has been ascertained for this convolution layer. The modified shift matrix may refer to the shift matrix that is used by the associated convolution layer during operation of the trained neural network.

The first normalization value and the second normalization value may each be used for normalizing the input matrix and/or may in each case refer to a value for normalizing the input matrix. The first normalization value and/or the second normalization value may be a scalar, a vector, a matrix, and/or a tensor. The first normalization value and the second normalization value may in each case generally be a value, such as a statistical value, that may be derived from inputs of the input matrix and/or from the training data set. For example, the first normalization value may correlate with a standard deviation, and/or the second normalization value may correlate with an average value. The average value may also be a weighted average value, it being possible, for example, for inputs of the input matrix to be weighted differently and/or for individual training images of the training data set to be weighted differently. In addition, the first normalization value and the second normalization value may be higher moments of a statistic, such as a skewness or inclination or a kurtosis or curvature. Within the scope of the method according to the present invention, any number of normalization values may generally be ascertained, with the aid of which the input matrix may be normalized using an addition, subtraction, multiplication, and/or division.

The present invention may be regarded in particular as based on the following described findings. During the training of artificial neural networks, training data elements, for example training images, may be normalized and/or standardized by subtracting an average value of inputs of the training data elements and dividing inputs of the training data elements by a standard deviation. The average value and the standard deviation may be global values and/or may be ascertained based on an overall training data set that includes multiple training data elements. All training data elements, all input data elements, and/or all input matrices of individual convolution layers may then be normalized using the global values of the standard deviation and of the average value. Alternatively, the average value and the standard deviation may be local values that may be ascertained separately for each training data element supplied to the neural network and/or each input data element supplied to the neural network and used for normalizing. In conventional methods for operating neural networks and/or in conventional neural networks, during operation of the trained neural network each input data element, such as an input image, fed into the neural network is generally normalized in this way. In addition, the input matrices of one or multiple convolution layers may be normalized in this way. This may sometimes require significant computing effort and/or computing time.

According to the present invention, it is therefore provided to combine the normalization and/or standardization with the convolution operation and/or the shift operation carried out by the convolution layer. A normalization operation, in particular a linear normalization operation, for normalizing the input matrix may thus be contained in and/or integrated into the modified filter matrix and the modified shift matrix. The normalization operation may generally involve an addition, subtraction, division, and/or multiplication of the input matrix with the first normalization value and/or the second normalization value and/or with further normalization values. In particular, the normalization operation may involve a subtraction of an average value from inputs of the input matrix and/or a division of the inputs of the input matrix by the standard deviation. By taking into account and/or integrating the first normalization value and the second normalization value into the modified filter matrix and the modified shift matrix, it is thus possible to carry out the convolution operation, the shift operation, and the normalization operation in combination and/or in one step. A separate step for carrying out the normalization operation may thus be dispensed with. In other words, the normalization operation may be integrated into the modified filter matrix and/or the modified shift matrix by integrating the first and/or second normalization value into the modified filter matrix and/or the modified shift matrix. Combining the normalization with the convolution operation and/or the shift operation may take place in an input layer and/or first layer of the neural network, via which the neural network may be supplied with input data elements such as input images. Alternatively or additionally, the convolution operation and/or shift operation applied by any other convolution layer to an input matrix of this convolution layer may be combined with the associated normalization operation of this input matrix. An explicit and/or separate normalization of the input data elements and/or the input matrices may be avoided in this way. Computing effort and/or computing time may thus be reduced overall, so that the neural network may have a faster and more efficient design. In addition, the trained neural network may thus be implemented on virtually any hardware and/or ported onto same, with little or no impairment of performance of the hardware. In addition, the hardware used for operating the neural network, in particular a processor and/or a graphics processor, may have a less powerful design, thus allowing costs to be saved.

According to one specific embodiment of the present invention, the first normalization value is a value that correlates with a standard deviation and/or is a standard deviation. The first normalization value may, for example, also be a reciprocal of the standard deviation and/or may correlate with the reciprocal of the standard deviation. Alternatively or additionally, the second normalization value is a value that correlates with an average value and/or is an average value. The second normalization value may, for example, also be a negative ratio of the average value to the standard deviation and/or may correlate with this ratio. The first and second normalization values may be ascertained based on inputs of the input matrix and/or based on a training data set.

According to one specific embodiment of the present invention, the modified filter matrix is determined based on, in particular based solely on, the original filter matrix and the ascertained first standard deviation. Alternatively or additionally, the modified shift matrix is determined based on the original shift matrix, based on the ascertained standard deviation and based on the ascertained average value. The standard deviation and the average value used for normalizing the input matrix may thus be integrated into the modified filter matrix and/or the modified shift matrix, so that a normalization of the input matrix to be carried out separately may be dispensed with.

According to one specific embodiment of the present invention, the ascertained average value is an average value of inputs of the input matrix. Alternatively or additionally, the ascertained standard deviation is a standard deviation of inputs of the input matrix. The average value and the standard deviation may therefore be ascertained as local values for the input matrix of the convolution layer. For each input matrix, an average value associated with this input matrix and/or a standard deviation associated with this input matrix may be ascertained in each case. If the associated convolution layer is the input layer, the ascertained average value may be an average value of the inputs of the associated input data element, for example an average value of pixels of an input image. Analogously, the standard deviation may be a standard deviation of the inputs of the associated input data element, for example of pixels of the input image.

According to one specific embodiment of the present invention, the training data set includes multiple training data elements, in particular training images, the standard deviation and the average value being ascertained based on the training data elements of the training data set. The average value and the standard deviation may therefore be ascertained as global values for the input matrix of the convolution layer. The same average value and the same standard deviation may thus be used for any input matrix and/or any input data element. This may further reduce the necessary computing effort and/or computing time.

According to one specific embodiment of the present invention, the step of converting the input matrix into the output matrix includes a convolution of the input matrix with the modified filter matrix, and an addition of the modified shift matrix to the convoluted input matrix. As explained above, the modified filter matrix and the modified shift matrix may contain the normalization operation for normalizing the input matrix. The input matrix may thus be simultaneously normalized, convoluted, and/or shifted in the convolution layer in order to generate the output matrix. Thus, the input matrix no longer has to be normalized before being supplied to the convolution layer, and instead, all computing operations applied to the input matrix may take place in one step.

According to one specific embodiment of the present invention, the step of ascertaining the modified filter matrix includes forming a ratio of inputs of the original filter matrix to the ascertained standard deviation. In other words, the modified filter matrix may be ascertained by dividing the inputs of the original filter matrix by the ascertained standard deviation. It may thus be ensured that the input matrix is correctly normalized. The inputs of the original filter matrix may refer to parameter values and/or weights of the particular convolution layer as ascertained during a training of the neural network.

According to one specific embodiment of the present invention, the step of ascertaining the modified shift matrix includes a step of convolution of the modified filter matrix with a normalization matrix, all inputs of the normalization matrix having the ascertained average value, and a step of subtracting the modified filter matrix, which is convoluted with the normalization matrix, from the original shift matrix. In other words, the modified shift matrix may be ascertained by forming the difference of the original shift matrix and the result of a convolution between the normalization matrix and the modified filter matrix. It may thus be ensured that the input matrix is correctly normalized. Inputs of the original shift matrix may refer to parameter values and/or weights of the particular convolution layer as ascertained during a training of the neural network.

According to one specific embodiment of the present invention, the method also includes a step of converting the input matrix into a higher-dimensional input matrix with addition of inputs to the input matrix. When the neural network is trained and/or during operation of the trained neural network or during inference, the added inputs have the ascertained average value in each case. Alternatively or additionally, during a training of the neural network the added inputs have a value of zero in each case. By adding inputs to the input matrix, a dimension of the output matrix after applying the convolution operation may advantageously match a dimension of the input matrix before adding the inputs. Adding inputs is also often referred to as “padding.” Thus, if zeroes are added to the input matrix of a convolution layer during the training of the neural network, inputs having the average value may be added to the input matrix for this convolution layer after the training, i.e., during operation of the trained network.

According to one specific embodiment of the present invention, when the neural network is trained, the inputs added to the input matrix have a value of zero in each case. Alternatively or additionally, during the training of the neural network the added inputs each have a negative value of the ratio of the ascertained average value to the ascertained standard deviation. Thus, during the training of the neural network, when inputs that correspond to the negative of the ratio of the ascertained average value to the ascertained standard deviation are added to the input matrix of a convolution layer, zeroes may be added to the input matrix for this convolution layer after the training, i.e., during operation of the trained network. In particular, the dimension of the output matrix may thus be maintained and/or may match the dimension of the input matrix before adding the inputs.

According to one specific embodiment of the present invention, the at least one convolution layer is an input layer and/or a first layer of the neural network. Alternatively or additionally, the input matrix is an input data element, in particular an input image, which is supplied to the neural network for interpretation and/or classification. The input data element may have an arbitrary dimension and/or may be an input image with an array including an arbitrary number of pixels. The pixels of the input image may be inputs of the input data element and/or inputs of the input matrix of the input layer.

According to one specific embodiment of the present invention, the modified filter matrix and the modified shift matrix are used solely in the input layer of the neural network. It is thus possible to further increase efficiency of the method for operating the neural network and/or to further reduce the computing effort and/or the computing time.

According to one specific embodiment of the present invention, the neural network includes multiple convolution layers, each of which is configured to convert an input matrix of the particular convolution layer into an output matrix of the particular convolution layer, a modified convolution matrix and a modified shift matrix being ascertained for each convolution layer, and each input matrix of each convolution layer being converted into an output matrix, applying the modified filter matrix ascertained for the particular convolution layer and the modified shift matrix ascertained for the particular convolution layer. The modified filter matrix and the modified shift matrix may be ascertained based on the original filter matrix and the original shift matrix of the particular convolution layer.

According to one specific embodiment of the present invention, an output matrix of at least one convolution layer forms an input matrix of at least one convolution layer downstream from this convolution layer, so that the average value and the standard deviation for the downstream convolution layer are ascertained based on this output matrix. In other words, the output matrix of an upstream convolution layer may correspond to the input matrix of a convolution layer situated directly downstream from this upstream convolution layer.

A further aspect of the present invention relates to an artificial neural network. The neural network is configured to carry out the method for operating the neural network as described above and explained below. The neural network may in particular be implemented on a processor and/or may include a processor.

Features, elements, and/or steps of the method for operating the neural network may be features and/or elements of the neural network, and vice versa. In other words, the disclosure with regard to the method similarly applies to the disclosure with regard to the neural network, and vice versa.

In particular, the neural network may include at least one convolution layer that is configured to convolute an input matrix with a modified filter matrix, and to add the convoluted input matrix to a modified shift matrix in order to generate an output matrix of the convolution layer. Inputs of the modified filter matrix may correlate with a ratio of inputs of an original filter matrix of the convolution layer to a standard deviation. The inputs of the modified filter matrix may be specified, for example, by the ratio of the inputs of the original filter matrix to the standard deviation. In addition, inputs of the modified shift matrix may correlate with a difference between an original shift matrix and the result of a convolution of the modified filter matrix with a normalization matrix, whose inputs have the ascertained average value in each case. In other words, the inputs of the modified shift matrix may be specified by the difference between the original shift matrix and the result of the convolution of the modified filter matrix with the normalization matrix. The standard deviation and the average value may be ascertained based on inputs of the input matrix and/or based on a training data set of the neural network.

The method according to the present invention for operating the neural network and/or the neural network may be advantageously used in many industrial sectors. In particular, the method and/or the neural network may be used in the field of autonomous driving, for example in a motor vehicle. For example, the method and/or the neural network may be used for object recognition based on image data. By use of the method and the neural network according to the present invention, in particular a recognition of traffic signs, pedestrians, obstacles, and/or other objects in the image data may be carried out. For example, image data and/or images may be recorded with a camera of a motor vehicle and supplied to the neural network for object recognition. The neural network may interpret, process, and/or handle the image data. The neural network in particular may carry out a classification of objects contained in the image data and output an appropriate output. For example, based on the processing of the image data, the neural network may ascertain at least one probability value and/or a probability with which an object contained in the image data may be associated with a certain class of objects and/or an object class. Alternatively or additionally, the neural network may ascertain the class of objects and/or the object class with which the object contained in the image data may be associated. The object class and/or the at least one probability value may be output and/or provided by the neural network. The output may be supplied, for example, to a control unit of the motor vehicle which, based on the output, may derive a vehicle control, for example an evasive maneuver and/or a brake application. The control unit may also prompt the motor vehicle to carry out the derived or ascertained vehicle control, in particular for carrying out the evasive maneuver and/or the brake application. A method for operating a vehicle may thus be implemented with the aid of the neural network. Alternatively or additionally, a warning device, for example for outputting an acoustic or visual warning signal, may be actuated based on the output of the neural network.

In addition, the method and the neural network may be advantageously used for the segmentation of image data. Furthermore, the method and the neural network may be used for analyzing medical images and/or medical image data, for example to detect diabetes in a patient. The method and the neural network may also be employed and/or used in robotics, for example for controlling a robot, in particular based on image data. Another possible field of application of the neural network and/or of the method is quality control, for example for identifying defective manufactured goods based on image data and/or other data.

Exemplary embodiments of the present invention are explained below with reference to the figures.

### BRIEF DESCRIPTION OF THE DRAWINGS

Exemplary embodiments of the present invention are described in greater detail below with reference to the figures.

FIG. 1 shows an artificial neural network according to one exemplary embodiment of the present invention.

FIG. 2 shows a flow chart for illustrating steps of a method for operating a neural network according to one exemplary embodiment of the present invention.

FIG. 3 shows a flow chart for illustrating steps of a method for operating a neural network according to one exemplary embodiment of the present invention.

FIG. 4 shows a flow chart for illustrating steps of a method for operating a neural network according to one exemplary embodiment of the present invention.

The figures are strictly schematic and are not true to scale. Identical, functionally equivalent, or similar elements are provided with the same reference numerals in the figures.

### DETAILED DESCRIPTION OF EXAMPLE EMBODIMENTS

FIG. 1 shows an artificial neural network 10 according to one exemplary embodiment of the present invention. Artificial neural network 10 illustrated in FIG. 1 is designed as a multilayer neural network 10 by way of example.

Neural network 10 may be used, for example, for interpreting image data, for example within the scope of an object recognition in a motor vehicle. Neural network 10 may, for example, be coupled to a memory device 11 and/or may include a memory device 11 for storing image data. The image data may be recorded, for example, with a camera of the motor vehicle and stored in memory device 11 for further processing and/or interpretation by neural network 10. The image data may include one or multiple images, which may be supplied to neural network 10 and/or fed into neural network 10.

Artificial neural network 10 includes an input layer 12a and/or a first layer 12a that is supplied with an input matrix I₀. Input layer 12a of a neural network 10 is generally a convolution layer. First layer and/or input layer 12a may therefore be referred to as a first convolution layer 12a of neural network 10. Input matrix I₀ supplied to input layer 12a may be an input data element I₀ and/or an input image I₀, for example. The input data element, the input image, and/or input matrix I₀ of first layer 12a may be an arbitrary array that includes an arbitrary number of pixels, the pixels corresponding to inputs of input matrix I₀. The input data element, the input image, and/or input matrix I₀ of input layer 12a may in particular be an individual image of the image data stored in memory device 11. The input data element, the input image, and/or input matrix I₀ of input layer 12a may be supplied to neural network 10 without preprocessing, in particular without carrying out a normalization and/or standardization beforehand, as explained in greater detail below.

In addition, neural network 10 includes multiple convolution layers 12b, 12c. Neural network 10 may include an arbitrary number of convolution layers 12b, 12c. Convolution layer 12b is situated directly downstream from input layer 12a and/or is coupled to same. Analogously, convolution layer 12c is situated downstream from convolution layer 12b, it being optionally possible for further convolution layers and/or further layers of neural network 10 to be situated between convolution layers 12b, 12c.

Input layer 12a and convolution layers 12b, 12c are generally configured to convert input matrix I₀, I₁, Iₙ, supplied to respective layer 12a through 12c, into an output matrix A₀, A₁, Aₙ₋₁ of respective layer 12a through 12c, based on a convolution operation and a shift operation, in particular a linear shift. In other words, each of layers 12a through 12c is designed to carry out a convolution operation and a shift operation. In the exemplary embodiment illustrated in FIG. 1, input layer 12a generates an output matrix A₀ of input layer 12a from input matrix I₀ by applying the convolution operation and the shift operation. Based on output matrix A₀ of input layer 12a, an input matrix I₁ for convolution layer 12b directly downstream from input layer 12a may then be generated. For this purpose, output matrix A₀ of input layer 12a may be modified, and/or output matrix A₀ of input layer 12a may form input matrix I₁ of convolution layer 12b. Analogously, an output matrix Aₙ₋₁ of a convolution layer directly upstream from convolution layer 12c may form input matrix Iₙ of convolution layer 12c, as illustrated in FIG. 1.

Details of the convolution operation and the shift operation carried out by each of convolution layers 12a through 12c are explained with reference to the subsequent figures.

Neural network 10 may ascertain, provide, and/or output an output 14 as the result of processing and/or interpreting the input matrix, the input data element, and/or input image I₀. Output 14 may be, for example, an object class with which an object contained in input image I₀ may be associated. Alternatively or additionally, output 14 may have one or multiple probability values. Each probability value may indicate a probability with which an object contained in input image I₀ may be associated with a certain object class.

When neural network 10 is used in a motor vehicle for recognizing an obstacle, output 14 may also be supplied to a control unit of the motor vehicle, which, based on output 14, may for example ascertain an evasive maneuver and/or a brake application and prompt the motor vehicle to carry out this evasive maneuver and/or brake application.

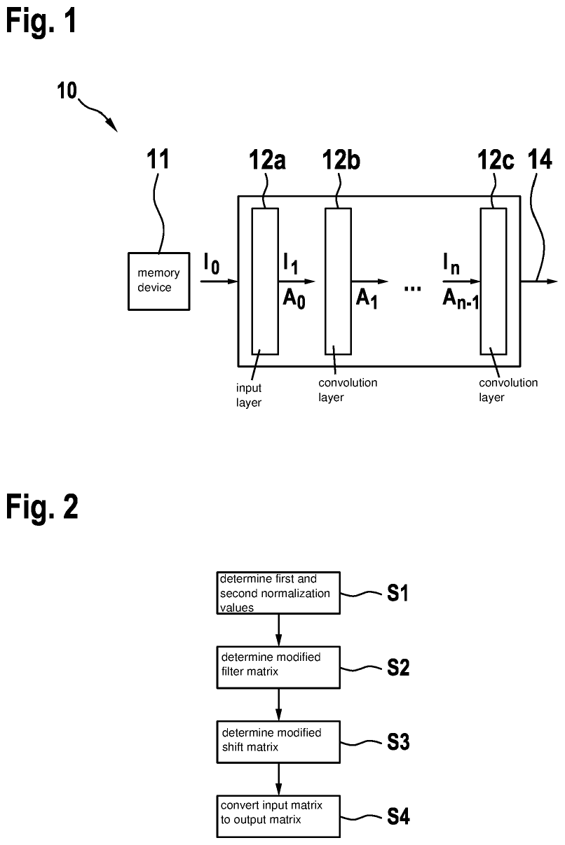

FIG. 2 shows a flow chart for illustrating steps of a method for operating a neural network 10 according to one exemplary embodiment of the present invention. Unless stated otherwise, neural network 10 described in FIG. 2 includes the same elements and features as neural network 10 described with reference to FIG. 1.

In general, neural network 10 described with reference to FIG. 2 includes at least one convolution layer 12a through 12c that is configured to convert an input matrix Iᵢ, i=0 . . . n into an output matrix Aᵢ, i=0 . . . n. Indices i=0 . . . n are omitted in the following discussion for simplification. The method described below may be carried out for any convolution layer 12a through 12c. In other words, the method described below may refer to one, multiple, or all convolution layers 12a through 12c.

At least one first normalization value v and one second normalization value w are determined in a first step S1. First normalization value v may correlate with a standard deviation σ, may be a reciprocal of the standard deviation, and/or may be a standard deviation σ. Second normalization value w may correlate with an average value μ, may be an average value μ, and/or may be the negative ratio of the average value to the standard deviation. First normalization value v, second normalization value w, standard deviation σ, and/or average value μ may be ascertained based on input matrix I and/or based on inputs of input matrix I of particular convolution layer 12a through 12c. For this purpose, average value μ may be ascertained as average value μ of all inputs of input matrix I. In addition, individual inputs of the input matrix may be weighted differently for ascertaining average value μ. Analogously, standard deviation σ may be ascertained as standard deviation σ of all inputs of input matrix I. For one or multiple convolution layers 12a through 12c, standard deviation σ and average value μ may be ascertained in each case for corresponding convolution layer 12a through 12c, based on input matrix I that is supplied to this convolution layer 12a through 12c.

Alternatively or additionally, first normalization value v, second normalization value w, standard deviation σ, and/or average value μ may be ascertained based on a training data set of neural network 10. The training data set may include multiple training data elements, in particular multiple training images. Average value μ may thus be an average value of all inputs of all training data elements of the training data set. In addition, individual training images may be weighted differently for ascertaining average value μ. Analogously, standard deviation σ may be a standard deviation of all inputs of all training data elements of the training data set. Standard deviation σ and average value μ ascertained in this way may then be used for one, multiple, or all convolution layers 12a through 12c.

First normalization value v and/or the second normalization value, in particular the standard deviation and/or average value μ, may also be modified in step S1, for example by adding a value and/or by multiplying by a factor.

A modified filter matrix \tilde{f} is determined in a further step S2, based on an original filter matrix \tilde{f} of convolution layer 12a through 12c and based on ascertained first normalization value v, for example ascertained standard deviation σ.

A modified shift matrix \tilde{b} is determined in a further step S3, based on an original shift matrix b of convolution layer 12a through 12c, based on first normalization value v, and based on second normalization value w. Modified shift matrix \tilde{b} may be determined, for example, based on original shift matrix b of convolution layer 12a through 12c, based on ascertained standard deviation σ, and based on ascertained average value μ.

Thus, a normalization operation for input matrix I may be contained in modified filter matrix \tilde{f} and modified shift matrix \tilde{b}, so that the convolution operation carried out by convolution layer 12a through 12c and the shift operation carried out by convolution layer 12a through 12c may be combined with the normalization operation. An explicit and/or separate normalization of input matrix I may be avoided in this way.

In conventional methods for operating a neural network, input matrix I is initially normalized, and subsequently convoluted with original filter matrix f and shifted with original shift matrix b. In general, input matrix I may be normalized and/or standardized with the aid of first normalization value v and second normalization value w. In particular, for normalizing, inputs of input matrix I and/or input matrix I may be multiplied by first normalization value v, and second normalization value w may be added to the result of this multiplication. In conventional neural networks, normalized input matrix I is then convoluted with original filter matrix f and shifted with original shift matrix b, as indicated in the following equation:

(vI+w)*f+b

Using modified filter matrix \tilde{f} ascertained in step S2 and modified shift matrix \tilde{b} ascertained in step S3, the above equation may be restated as follows:

(vl+w)*f+b=I*vf+w*f+b=\tilde{f}+\tilde{b},

where

\tilde{f}=vf

is the modified filter matrix and

\tilde{b}=w*_{f}+b

is the modified shift matrix.

Input matrix I is then converted into output matrix A in a further step S4. For this purpose, input matrix I is convoluted with modified filter matrix \tilde{f}, and the result of this convolution is shifted by addition to modified shift matrix \tilde{b}, as indicated in the following equation:

I*\tilde{f}+\tilde{b}=A

In the following discussion, the method explained above is described for the case that first normalization value v is a value that correlates with standard deviation σ, and second normalization value w is a value that correlates with average value μ.

In conventional neural networks 10 and/or in a conventional method for operating neural network 10, for normalizing the input matrix, it is customary to subtract average value μ from each entry of input matrix I and to divide the result of this difference by standard deviation σ. The result of this normalization is then convoluted with original filter matrix f and linearly shifted with original shift matrix b, as indicated in the following equation:

$$\frac{I - \tilde{μ}}{σ} * f + b ,$$

where \tilde{μ} is a normalization matrix and/or average value matrix whose inputs all have average value μ and have the same dimension as input matrix I. Original shift matrix b has the same dimension as the result of the convolution of the normalized input matrix with original filter matrix f, and all inputs of shift matrix b have a constant value b.

Using modified filter matrix \tilde{f} ascertained in step S2 and modified shift matrix \tilde{b} ascertained in step S3, the above equation may be restated as follows:

$$\frac{I - \tilde{μ}}{σ} * f + b = I * \frac{f}{σ} - \tilde{μ} * \frac{f}{σ} + b = I * \tilde{f} + \tilde{b} ,$$

where

$$\tilde{f} = \frac{f}{σ}$$

is the modified filter matrix and

$$\tilde{b} = - \tilde{μ} * \frac{f}{σ} + b$$

is the modified shift matrix.

First normalization value v may thus be a reciprocal of standard deviation σ and/or may correlate with the reciprocal, and second normalization value w may be the negative of the ratio of average value μ to standard deviation σ and/or may correlate with this ratio.

Input matrix I is then converted into output matrix A in a further step S4. For this purpose, input matrix I is convoluted with modified filter matrix \tilde{f}, and the result of this convolution is shifted by addition to modified shift matrix \tilde{b}, as indicated in the following equation:

I*\tilde{f}+\tilde{b}=A

As is apparent from the above four equations, via modified filter matrix \tilde{f} and modified shift matrix \tilde{b}, the normalization of input matrix I may advantageously take place together with the convolution of input matrix I with modified filter matrix \tilde{f} and together with the shift of the result of this convolution by modified shift matrix \tilde{b}.

The method explained above may take place in input layer 12a. In particular, the explained method may take place solely in input layer 12a. Alternatively, the explained method may be carried out in any, in particular in all, convolution layers 12a through 12c.

In the following discussion, the method according to the present invention is compared to a conventional method for operating the neural network. In the conventional method, input matrix I is initially normalized, and the result of the normalization is convoluted with original filter matrix f. The result of this convolution is then added to the original shift matrix in order to generate output matrix A. The conventional method may thus be described with the equation

$$\frac{I - \tilde{μ}}{σ} * f + b = A .$$

In the conventional method, the normalization operation and the convolution and shift are thus separate. The first step is the normalization, which for each input matrix I is carried out during the training of neural network 10 as well as during operation of trained neural network 10. The normalization encompasses subtracting average value μ from all inputs of input matrix I, and dividing by standard deviation σ. In the conventional method, the normalized input matrix is convoluted with original filter matrix f in a second step, and the result of this convolution is shifted by addition to the original shift operation.

In contrast, in the method according to the present invention the normalization operation is combined with the convolution operation and the shift operation by applying modified filter matrix \tilde{f} and modified shift matrix \tilde{b}. For ascertaining modified filter matrix \tilde{f}, the inputs of filter matrix f are divided by standard deviation σ. Step S2 may thus include a substep of ascertaining the ratio of inputs of original filter matrix f to standard deviation σ. For ascertaining modified shift matrix \tilde{b}, in addition modified filter matrix \tilde{f} is convoluted with normalization matrix \tilde{μ}, and the result of this convolution is subtracted from original shift matrix b. In this way, input matrix I in the unchanged and/or non-normalized form may be converted into output matrix A, using modified filter matrix \tilde{f} and modified shift matrix \tilde{b}.

If standard deviation σ and average value μ are ascertained based on the training data set, modified filter matrix \tilde{f} and modified shift matrix \tilde{b} may be ascertained once, and during operation of trained neural network 10 no further adaptation of input matrix I, modified filter matrix \tilde{f}, and/or modified shift matrix \tilde{b} is necessary. This may significantly reduce the computing effort and/or the computing time for processing an input data element and/or an input image I by neural network 10 in comparison to the conventional method, since in the conventional method each input matrix I is initially normalized before it may be supplied to neural network 10.

In contrast, if standard deviation σ and average value μ are ascertained based on input matrix I, it may be necessary to adapt modified filter matrix f and modified shift matrix b for particular convolution layer 12a through 12c, based on standard deviation σ of this input matrix I and based on average value μ of this input matrix I. However, since modified filter matrix \tilde{f} and modified shift matrix \tilde{b} generally have a smaller dimension than input matrix I, in this case as well the computing effort and/or the computing time may be significantly reduced in comparison to the conventional method.

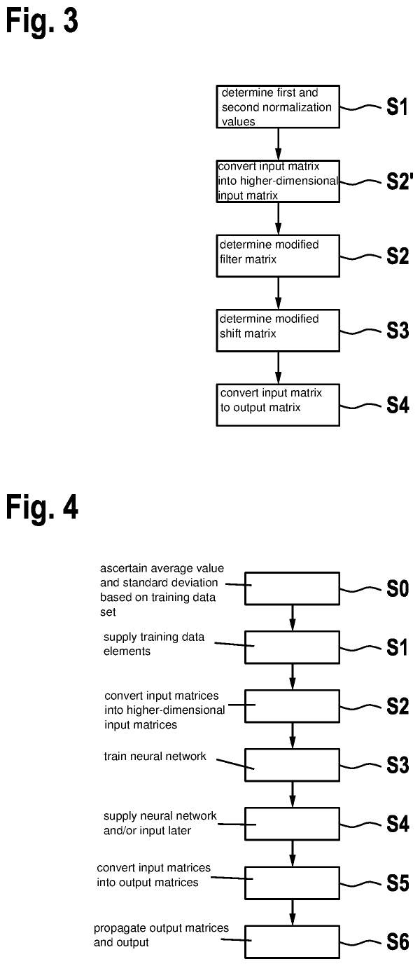

FIG. 3 shows a flow chart for illustrating steps of a method for operating a neural network 10 according to one exemplary embodiment of the present invention. Unless stated otherwise, the method described in FIG. 3 includes the same elements, features, and steps as the method described in FIG. 2. In particular, steps S1 through S4 may be designed analogously to the method of FIG. 2.

The method illustrated in FIG. 3 includes an optional step S2′ in which input matrix I is converted into a higher-dimensional input matrix Ĩ with addition of inputs. This operation is also often referred to as “padding,” and may be used in particular to compensate for a reduction, resulting from the convolution, in the dimension of output matrix A in comparison to input matrix I, so that output matrix A may have the same dimension as input matrix I.

The equations described for FIG. 2 apply in particular for the case that no padding is applied. In this case, the associated convolution operation of input matrix I with modified filter matrix \tilde{f} is also referred to as “valid convolution.” Neural network 10 here may be trained in the regular manner, i.e., analogously to the conventional method, in which input matrix I may be normalized with first normalization value v and second normalization value w, for example standard deviation σ and the average value. However, input matrix I of a convolution layer situated downstream from the convolution layer in which the method according to the present invention is carried out may be converted into higher-dimensional input matrix Ĩ by adding inputs having the value zero, so-called “zero padding.”

Thus, if during the training of neural network 10, for a convolution layer 12a through 12c in which the method according to the present invention is implemented, no inputs are added to input matrices I (training images or training data elements, for example) supplied to this convolution layer 12a through 12c, input matrices I supplied to this convolution layer 12a through 12c also during operation of trained neural network 10 may be supplied without adding inputs to input matrices I. After the training of neural network 10, i.e., during operation of trained neural network 10, the convolution operation and the shift operation may thus take place according to the method according to the present invention described in FIG. 2.

In contrast, if during the training of neural network 10 a padding is carried out, and/or during the training of input matrix I, inputs are added to a convolution layer 12a through 12c in which the method according to the present invention is implemented, it may be necessary to add inputs to input matrix I of this convolution layer 12a through 12c, also during operation of trained neural network 10, in order to convert input matrix I into higher-dimensional input matrix Ĩ. If the number of added inputs is selected in such a way that the dimension is the same after the convolution, this is also often referred to as a “same convolution.” Depending on the hardware on which neural network 10 is implemented, inputs containing zeroes (so-called “zero padding”) and/or inputs having constant values different from zero (so-called “non-zero padding”) may be added to input matrix I.

For example, during the training of neural network 10, the input matrix may be normalized in the conventional manner by multiplying the input matrix by first normalization value v and by adding second normalization value w. In addition, during the training of input matrix I, inputs having a value of zero (zero padding) may be added to a convolution layer 12a through 12c in which the method according to the present invention is implemented. After the training, trained neural network 10 may be implemented on hardware and/or ported onto same, and modified filter matrix \tilde{f} and modified shift matrix \tilde{b} may be used in particular convolution layer 12a through 12c, in this case inputs, which in each case may have the negative ratio of second normalization value w to first normalization value v (non-zero padding), being added to input matrix I in step S2′ during operation of already trained neural network 10.

If during the training of neural network 10 the input matrix is normalized in the conventional manner by subtracting average value μ from the inputs of input matrix I and by dividing by standard deviation σ, and during the training of input matrix I, inputs having a value of zero (zero padding) are added to a convolution layer 12a through 12c in which the method according to the present invention is implemented, trained neural network 10 after the training may be implemented on hardware and/or ported onto same, and modified filter matrix \tilde{f} and modified shift matrix \tilde{b} may be used in particular convolution layer 12a through 12c, in this case inputs, which in each case have average value μ (non-zero padding) ascertained in step S1 being added to input matrix I in step S2′ during operation of already trained neural network 10.

Alternatively, during the training of neural network 10, the input matrix may be normalized in the conventional manner by multiplying the input matrix by first normalization value v and by adding second normalization value w, and during the training of input matrix I, inputs which in each case have a value of second normalization value w (non-zero padding) may be added to a convolution layer 12a through 12c in which the method according to the present invention is implemented. After the training, trained neural network 10 may be implemented on hardware and/or ported onto same, and modified filter matrix \tilde{f} and modified shift matrix \tilde{b} may be used in particular convolution layer 12a through 12c, in this case inputs which in each case have the value zero (zero padding) being added to input matrix I in step S2′ during operation of already trained neural network 10.

If during the training of neural network 10 the input matrix is normalized in the conventional manner by subtracting average value μ from the inputs of input matrix I and by dividing by standard deviation σ, and during the training of input matrix I, inputs which in each case have a value of the negative ratio of average value μ to standard deviation σ, i.e., a value of −μ/σ (non-zero padding), are added to a convolution layer 12a through 12c in which the method according to the present invention is implemented, trained neural network 10 after the training may be implemented on hardware and/or ported onto same, and modified filter matrix \tilde{f} and modified shift matrix \tilde{b} may be used in particular convolution layer 12a through 12c, in this case inputs which in each case have the value zero (zero padding) being added to input matrix I in step S2′ during operation of already trained neural network 10.

For example, the above-described addition of inputs to input matrix I may take place solely in input layer 12a of the neural network. For all other convolution layers 12b, 12c, during operation of trained neural network 10 the same padding may be used as during the training. However, the above-described addition of inputs to input matrix I may alternatively take place in any of convolution layers 12a through 12c.

FIG. 4 shows a flow chart for illustrating steps of a method for operating a neural network 10 according to one exemplary embodiment of the present invention. In particular, the method illustrated in FIG. 4 includes the training of neural network 10 and the operation of already trained neural network 10. As an example, in the following discussion the method according to the present invention is carried out only in input layer 12a, but may optionally also be implemented in any convolution layer 12a through 12c. Unless stated otherwise, the method described in FIG. 4 includes the same elements, features, and steps as the method described in the figures described above.

In a step S0 preceding the training of neural network 10, average value μ and standard deviation σ are ascertained based on a training data set, as explained for FIG. 2. Step S0 may therefore also include a substep of providing a training data set, for example in a memory device 11. Alternatively, as described for FIG. 2, average value μ and standard deviation σ may also be computed based on input matrix I.

During the training of neural network 10, neural network 10 or input layer 12a is supplied with training data elements, such as training images, in step S1. These may be normalized in step S1 by subtracting average value μ from the inputs of each training data element, and dividing the result of this subtraction by standard deviation σ. The training data elements may in a manner of speaking represent an input matrix I, as described in the preceding figures, for input layer 12a.

These input matrices I or training data elements may be converted into higher-dimensional input matrices Ĩ or higher-dimensional training data elements in an optional step S2 by adding inputs having the value zero or by adding inputs having the value −μ/σ, as described in FIG. 3. If no inputs are added to input matrices I of input layer 12a, inputs, for example having a value of zero, may be added to output matrix A of input layer 12a in order to compensate for a convolution-related loss of dimension after input layer 12a.

The actual training of neural network 10 may then take place in a step S3. As a result of the training, the inputs of original filter matrix f and of original shift matrix b may be ascertained, which in a manner of speaking may refer to trained weights, parameters, and/or parameter values of neural network 10.

Trained neural network 10 may be implemented on hardware and/or ported onto hardware for operating trained neural network 10.

Non-normalized input data elements I, input matrices I, and/or input images I for interpretation and/or classification may be supplied to neural network 10 and/or to input layer 12a in a step S4.

If inputs having the value zero have been added to the training data elements in optional step S2, inputs having a value of μ are added to input matrices I in step S4. In contrast, if inputs having the value −μ/σ have been added to the training data elements in optional step S2, inputs having a value of zero are added to input matrices I in step S4. In contrast, if optional step S2 has not been carried out, no inputs are added to input matrices I.

Input matrices I of input layer 12a are then converted into output matrices A in a step S5 by applying modified filter matrix \tilde{f} and modified shift matrix \tilde{b}, as explained in detail for FIGS. 2 and 3.

Neural network 10 may also propagate output matrices A through further layers 12b, 12c, and may output output 14. Output 14 may be, for example, a predicted object class, a semantic segmentation, and/or any other value.

In addition, it is to be noted that “including” does not exclude other elements, and “a” or “an” do not exclude a plurality. In addition, it is pointed out that features that have been described with reference to one of the above exemplary embodiments may also be used in combination with other features of other exemplary embodiments described above.

1-15. (canceled)

16. A method for operating an artificial neural network, the artificial network including at least one convolution layer that is configured to convert an input matrix of the convolution layer into an output matrix, based on a convolution operation and a shift operation, the method comprising the following steps:
ascertaining at least one first normalization value and one second normalization value: (i) based on inputs of the input matrix and/or (ii) based on a training data set of the artificial neural network;
ascertaining a modified filter matrix based on an original filter matrix of the at least one convolution layer and based on at least one of the ascertained first normalization value and the ascertained second normalization value;
ascertaining a modified shift matrix based on an original shift matrix of the at least one convolution layer and based on at least one of the ascertained first normalization value and the ascertained second normalization value; and
converting the input matrix into the output matrix, based on the modified filter matrix and the modified shift matrix.

17. The method as recited in claim 16, wherein: (i) the first normalization value is a value that correlates with a standard deviation and/or is a standard deviation, and/or (ii) the second normalization value is a value that correlates with an average value and/or is an average value.

18. The method as recited in claim 17, wherein: (i) the modified filter matrix is ascertained based on the original filter matrix of the at least one convolution layer and based on the ascertained standard deviation, and/or (ii) the modified shift matrix is ascertained based on the original shift matrix of the at least one convolution layer, based on the ascertained standard deviation, and based on the ascertained average value.

19. The method as recited in claim 17, wherein the ascertained average value is an average value of inputs of the input matrix, and/or the ascertained standard deviation is a standard deviation of inputs of the input matrix.

20. The method as recited in claim 17, wherein the training data set includes multiple training data elements, the training data elements being training images, and wherein the standard deviation and the average value are ascertained based on the training data elements of the training data set.

21. The method as recited in claim 16, wherein the step of converting includes:
convoluting the input matrix with the modified filter matrix; and
adding the modified shift matrix to the convoluted input matrix.

22. The method as recited in claim 16, wherein a normalization operation for normalizing the input matrix is contained in the modified filter matrix and the modified shift matrix.

23. The method as recited in claim 17, wherein the step of ascertaining the modified filter matrix includes:
forming a ratio of inputs of the original filter matrix to the ascertained standard deviation.

24. The method as recited in claim 17, wherein the step of ascertaining the modified shift matrix includes:
convoluting the modified filter matrix with a normalization matrix, all inputs of the normalization matrix including the ascertained average value; and
subtracting the modified filter matrix, which is convoluted with the normalization matrix, from the original shift matrix.

25. The method as recited in claim 17, further comprising the following step:
converting the input matrix into a higher-dimensional input matrix with addition of inputs to the input matrix;
wherein: (i) when the neural network is trained, the added inputs have the ascertained average value in each case, and/or (ii) during the training of the neural network, the added inputs have a value of zero in each case.

26. The method as recited in claim 17, further comprising the following step:
converting the input matrix into a higher-dimensional input matrix with addition of inputs to the input matrix;
wherein: (i) when the neural network is trained, the added inputs having a value of zero in each case, and/or (ii) during the training of the neural network, the added inputs each have a negative value of a ratio of the ascertained average value to the ascertained standard deviation.

27. The method as recited in claim 16, wherein: (i) the at least one convolution layer is an input layer of the neural network, and/or (ii) the input matrix is an input data element, that is supplied to the neural network for interpretation and/or classification, the input data element being an input image.

28. The method as recited in claim 27, wherein the modified filter matrix and the modified shift matrix are used solely in the input layer of the neural network.

29. The method as recited in claim 16, wherein the neural network includes multiple convolution layers, each convolutional layer of the convolutional layers being configured to convert an input matrix of the convolution layer into an output matrix of the convolution layer, wherein a modified filter matrix and a modified shift matrix being ascertained for each of the convolution layers, and wherein each input matrix of each convolution layer being converted into an output matrix, applying the modified filter matrix ascertained for the convolution layer and the modified shift matrix ascertained for the convolution layer.

30. An artificial neural network including at least one convolution layer that is configured to convert an input matrix of the convolution layer into an output matrix, based on a convolution operation and a shift operation, the artificial neural network configured to:
ascertain at least one first normalization value and one second normalization value: (i) based on inputs of the input matrix and/or (ii) based on a training data set of the artificial neural network;
ascertain a modified filter matrix based on an original filter matrix of the at least one convolution layer and based on at least one of the ascertained first normalization value and the ascertained second normalization value;
ascertain a modified shift matrix based on an original shift matrix of the at least one convolution layer and based on at least one of the ascertained first normalization value and the ascertained second normalization value; and
convert the input matrix into the output matrix, based on the modified filter matrix and the modified shift matrix.
